(19) United States
(12) Patent Application Publication
(10) Pub. No.: US 2015/0234247 A1
(43) Pub. Date: Aug. 20, 2015

(54) FERROELECTRIC LIQUID CRYSTAL DISPLAY CELL

(71) Applicants: Igor Nikolaevich KOMPANETS, (US); Aleksandr Lvovich ANDREEV, (US); Tatyana Borisovna ANDREEVA, (US)

(72) Inventors: Igor Nikolaevich Kompanets, Moscow (RU); Aleksandr Lvovich Andreev, Moscow (RU); Tatyana Borisovna Andreeva, Moscow (RU)

(21) Appl. No.: 14/404,420

(22) PCT Filed: May 29, 2013
(86) PCT No.: PCT/RU2013/000440

§ 371 Date: Apr. 13, 2015

(30) Foreign Application Priority Data
May 30, 2012 (RU) 2012122121

(51) Int. Cl. G02F 1/141

(52) U.S. Cl. CPC G02F 1/141

(57) ABSTRACT

The invention relates to the field of optoelectronics, and may be used in devices and systems of visualization, displaying, storage and processing of information, in particular in two-dimensional and three-dimensional displays, light modulators, including spatial ones, devices of image processing and recognition etc,

Ferroelectric liquid crystal display cell contains two flat transparent plates disposed parallel one above the other, on one side of which polarizers are superimposed, and on the other—transparent conductive coatings connected to a source of alternating electric voltage, which set-on the surface a preferred direction to provide the uniform orientation of liquid crystal molecules, ferroelectric liquid crystal in the space between the transparent conductive coatings of plates and changing its optical anisotropy under an electric field action. The liquid crystal is selected helix-free, and values of the rotational viscosity, spontaneous polarization and modulus of elasticity, which determines the deformation along the smectic layers, are in the ratio (each with other), which provides the presence of periodic spatial deformations along the smectic layers and the characteristic dependence of the birefringence of the display cell on the frequency of the electric field, Technical result: continuous hysteresis-free modulation characteristic on light modulation frequencies of several kilohertz under the control voltage ±1.5 V (alternating pulses), decrease of the energy consumption, improving the optical contrast.

### FIELD OF TECHNOLOGY

The invention relates to the field of optoelectronics, and may be used in devices and systems of visualization, displaying, storage and processing the information with high information capacity, particularly in two-dimensional and three-dimensional displays, including computer and television displays, in light modulator including spatial ones, in devices of image processing and recognition, data storage and conversion, and so on.

### BACKGROUND OF THE INVENTION

Presently, liquid crystal (LC) displays and spatial light modulators are the most popular types of such devices: only the LCD displays are produced in the world annually about one billion units. Mostly, they use nematic liquid crystals (NLC). The basis for the creation of an entire LCD industry is high effectiveness of the electro-optical light modulation in NLC (due to a large value of the birefringence change) at a low control voltage (a few volts) [1-3].

To observe the light modulation a liquid crystal display cell with NLC is placed between crossed polarizers (polarizer and analyzer). Modulation characteristic is smooth and in general for various electro-optical effects obeys the law

I=I₀·sin²(Γ/2), (1)

where I₀ and I− the intensity of light incident on the polarizer and passed the analyzer, respectively, and Γ=2π·Δn·d/λ—phase delay between the ordinary and extraordinary rays, determined by the magnitude of the birefringence change Δn, NLC layer thickness d and the modulated wave length λ. This characteristic provides good halftones (grayscale), and colors also.

The times of the reorientation of NLC molecules in a display cell and thereby the times of switching on and off that or another electrooptical effect used for the light modulation are described by ratios:

τₒₙ=4πγ₁d²/(Δε·U²−4π³K), (2)

τ_{off=γ}₁d²/π²K, (3)

where γ_{I}—rotational viscosity; K—the modulus of elasticity; Δε—anisotropy of the dielectric constant, equal to the difference between the dielectric constants, measured along the longest (ε_{∥}) and short (ε_{⊥}) molecular axes, respectively: d—thickness of LC layer; U—amplitude of the applied voltage.

Electro-optical response time for the applied voltage τₒₙ is from a few to tens of milliseconds, and does not depend on the sign of the voltage due to the quadratic dependence on the voltage for all electro-optic effects in NLC. After switching off the voltage the molecules are reoriented back to the initial state by the force caused by the elastic deformation of the NLC layer molecular structure. The time τ_{off} of switching off (relaxation) is independent of the voltage; it is directly proportional to the square of the thickness of LC layer, is directly proportional to the ratio of the essential parameters γ₁/K and can vary from hundreds of milliseconds to milliseconds. This time limits the speed of NLC display cells and the frame rate of NLC display at 120-160 Hz.

The increase of the elastic force, for example a 270 degree twist in NLC layer of super-twist structures [3], leads to smaller value of the response time, but also to increasing the control voltage up to ten or more volts. At the same time, the low value of the supplied voltage and power is an important requirement of compatibility of high frequency addressing of the display elements with integral control circuits. The problem was also to use heating NLC (to reduce a viscosity) in very thin NLC cells, where the time of switching on-off of the basic part of a response was reduced to 1 ms at the control voltage of about 5 V, but the relaxation component of the response is stored, and the profit was not significant [4]. And the hopes are not justified in relative to use so-called “blue phase” [5], with which the frame rate can be increased to 240 Hz. Small temperature interval of existence of “blue phase” (no more 10° C.) and high control voltage (exceeds 10V) prevent this.

As it is known, in order to avoid strong flickering of images on TV screen and to reduce blurring the images of observed fast moving objects, for example, the flying ball, the frame rate was raised from 25 to 40-50 Hz, although in terms of medical prescriptions, i.e. comfortable viewing the reproduced images, it is necessary twice more. When the frame rate reached 3×40=120 Hz in modern displays it became possible to obtain more bright color images due to a sequential color change over time (and even tripled in reducing the number of display elements), but the perception at a frequency of 40 Hz for each color is not comfortable. The same can be said about the visualization of 3D stereo images on NLC screen of a monitor, implemented in the best case at frequencies of 60-80 Hz for each eye.

From the above it is clear that the complete absence of the flicker (i.e. medical contraindications) for progressive technology of sequential (in time) colors change and simultaneous three-dimensional information displaying can be achieved at the screen frame rates of not less than 540 Hz—90×3×2, and even better (to supply the display from 50 or 60 Hz electric net)—at the frequency of 600 Hz, and experts understand this [6]. Obviously, modern NLC displays significantly behind in speed from the requirements not only of tomorrow, but already today.

It is known that sub-millisecond electro-optical response is achieved in FLC—some smectic (smectic C*) liquid-crystals with ferroelectric properties; therefore they are very sensitive to the electric field action [7-9].

FIG. 1 illustrates the principle of light modulation of FLC electro-optical cell, when an electric field is supplied to it. Figure shows a helical structure of FLC (FIG. 1a) and relative position of the spontaneous polarization of the smectic layer and FLC director (FIG. 1b). Here 1—glass substrates, 2—transparent conductive coatings, 3—smectic layers, 4—alternating voltage generator, 5—polarizer, 6—analyzer, n—FLC director, P_{S}—spontaneous polarization vector, p₀—pitch of the helix, Θ₀—tilt angle of the molecules in smectic layers, φ—azimuthal angle of the director orientation, I₀ and I—intensity of light, incident and transmitted through the cell with FLC, respectively.

A distinctive feature of smectic LC is periodical ordering of the mass centers of molecules along the direction of orientation of their long axes (director) with a period of the order of the molecule length—the so-called smectic layers (FIG. 1a). In the absence of external influences the polar axis of the various smectic layers are rotated relative to each other so that a helical (spiral) “twist” of FLC director appears. In each layer the position of the director is determined by the polar angle Θ₀ and azimuth angle φ, which varies from 0 to 2π at a distance equal to the helix pitch p₀ (FIG. 1 a, b). Under the action of an electric field applied parallel to smectic layers 3 (along the coordinate x), the vector P_{S} in all layers orients along the field direction, As a consequence, the director assumes one direction throughout all FLC volume, i.e. helix as if unwinds. When the field sign changes the vector P_{S} reorients to 180°, so that the long axes of molecules unfold in a cone with the angle 2Θ₀, resulting in a change in the angle φ on 180°.

The direction of the director uniquely identifies the main optical axis of FLC refractive index ellipsoid, and director reorientation results in the change of the angle between the plane of polarization of incident light I₀ (light propagates along the coordinate x) and the main optical axis of the ellipsoid, that means the modulation of the phase delay between an ordinary and extraordinary rays, or modulation of the light intensity, if electro optical cell is located between crossed polarizers 5 and 6.

Unlike NLC, electro-optical effect in helix FLC is linear to the electric field [10], and as FLC responds to the sign of the applied voltage, then the optical response time for its switching on and switching off is the same and proportional to

τ_{R}˜γ_{φ}/P_{S}·E, (4)

where γ_{φ} FLC rotational viscosity, P_{S}—spontaneous polarization and E—electric field. Otherwise, the return to the initial state is carried out in FLC due to the pulse of opposite polarity, i. e., forcibly, and not as a result of relaxation (due to elastic forces) like in NLC. Therefore, the optical response at switching on and off is symmetric in time and very short, especially for FLC with the low viscosity and high spontaneous polarization.

For well known electro-optical effect by Clark-Lagerwall [11], implemented in thin (1-2 micrometers) layers of helix FLC the interaction of molecules with a surface results in a bistable mode switching (no halftone). Because of this using the effect is limited, despite the possibility to modulate light with a frequency of a few kHz at relatively low control voltage (3-6 V). Therefore, halftone (gray scale) and colors are formed electronically, exchanging the frequency of pulse modulation to a number of gray levels (in bits). Electronic base for this is so-called silicon control structure LCoS (Liquid Crystal on Silicon), developed for NLC based micro displays, which are widely used in helmet-mounted displays, video projectors, and various types of smart devices [12]. Micro display based on a structure with Ferroelectric LC and called FLCoS, is capable to display the color images of high-definition TV with much more frame rate than LCoS, but still it does not exceed 360 l/s [12, 13].

For other known electro-optical effect of Deformed Helix Ferroelectric (DHF-effect) [14, 15], originally implemented in relatively thick (a few micrometers and tens) layers of FLC, light modulation is possible with a frequency of several kHz, but the control voltage of the order of ten volts, hysteretic character of switching the optical properties and low optical contrast for a long time prevented the use of the effect. Later in the DHF-cell they obtained hysteresis-free modulation characteristic [16] and phase (0-2π) light modulation with a frequency of 2 kHz at the control voltage of ±32 V [17]. Such liquid crystal display DHF-cell with fast electro-optic response and continuous gray scale is described in U.S. patent application #61/344.070 [18], and it is one of the analogues of the claimed invention.

Closest to the claimed invention (prototype) is a ferroelectric liquid crystal display cell, made according to RF patent number 2,430,393. [19] This invention solves the problem of creating a display cell with helix FLC, which has hysteresis-free continuous gray scale modulation characteristic and allows to carry out the modulation of light with a frequency of 2 kHz for the cell addressed by alternating pulses of amplitude up to ±3 V (at the level of maximum change in the intensity of modulated light), at low power consumption due to the low applied voltage.

Ferroelectric liquid crystal display cell described in Russian patent #2430393, provides high (2 kHz) frequency of amplitude-phase light modulation with continuous and hysteresis-free modulation characteristic at rather small control voltage (±3 V). However, in this cell:
To reduce the response time according to (4) the helix-free FLC with rather high spontaneous polarization (up to 100 nC/cm²) is used, that increases the saturation voltage and hence the minimal voltage at which FLC cell can operate,
Deformation of the helix structure FLC layer at changes of the supplied voltage initiates creating the light scattering centers, and thereby reduces the optical contrast.

A task solved in the proposed ferroelectric liquid crystal display cell, is the obtaining in a cell the continuous hysteresis-free modulation characteristic that allows to implement the light modulation with a frequency of 3.5 kHz when a ceil is addressed by alternating pulses of amplitude only ±1,5 V (on the level of maximal change of modulated light intensity), with less power consumption due to half value of applied voltage, that more acceptable for the high frequency control silicon integrated circuits (ICs), without deformation of the helix structure (due to the lack of it) and with the best optical contrast (on the same reason). Thus the problem reduces to the creation of a liquid crystal ferroelectric display cell without disadvantages mentioned above for a ferroelectric liquid crystal display cell, manufactured according to RF patent #2430393, based on helix FLC.

### BRIEF DESCRIPTION OF THE DRAWINGS

In the drawings:

FIG. 1 a, —Helix FLC with planar orientation of the director in the electro-optical cell (a) and relative position of the vector of spontaneous polarization of smectic layer and FLC director (b), n—the director of FLC, P_{S}—spontaneous polarization vector, p₀—pitch of the helix, Θ₀—tilt angle of the molecules in the smectic layers, φ—azimuthal angle orientation of the director, I₀ and I—light intensity incident and transmitted through the ceil with FLC, respectively.

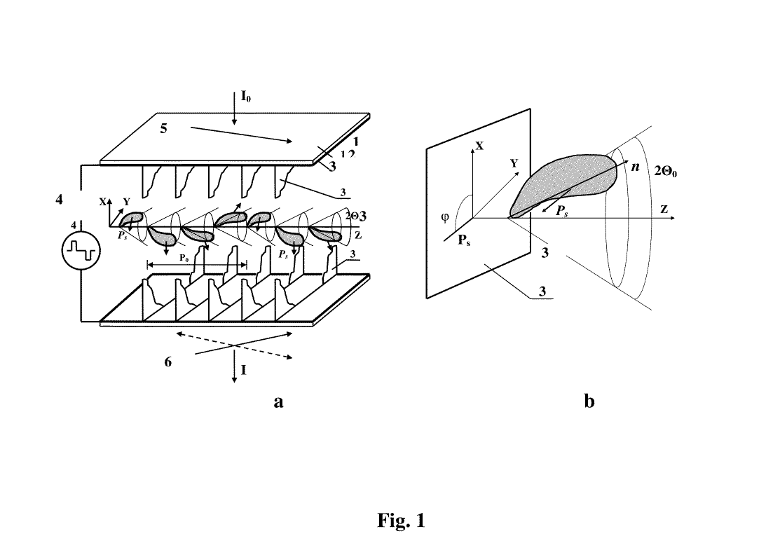

FIG. 2—Principal scheme of the ferroelectric liquid crystal display cell of “transmissive” (a) and “reflective” (b) type.

FIG. 3—The deformation of smectic layers in helix-free FLC with planar orientation of the director: the general picture (a) and a fragment (b). Θ₀—molecule tilt angle in smectic layers, ψ—tilt angle of the smectic layer, P_{S}—the vector of spontaneous polarization, d—thickness of the electro-optical cell, l—thickness of the smectic layer.

FIG. 4—Graph of the dependence of birefringence index Δn of helix-free FLC on the alternating electric field frequency f. Thickness of the electro-optical cell is of 1.7 micrometers. Amplitude of the control voltage (square wave) is ±1.5 V.

FIG. 5—The oscillogram from the oscilloscope Le Gray of the electro-optical response (pulses smoothed on corners, zero on line I) for a cell with helix-free FLC at the control voltage—±1.5 V (meander) and frequency 3542 Hz (rectangular pulses, zero on the line 3, a large vertical division −1 V), Electro-optical cell with dielectric coating on a substrate, the thickness of FLC layer is 1.7 micrometer. The upper level of the optical response—closed state, the bottom—transmissive state. Time τ_{0,1-0,9} on the front edge—Rise=34.90 microseconds, falling edge—Fall=35.1 microseconds.

### ESSENCE OF THE INVENTION

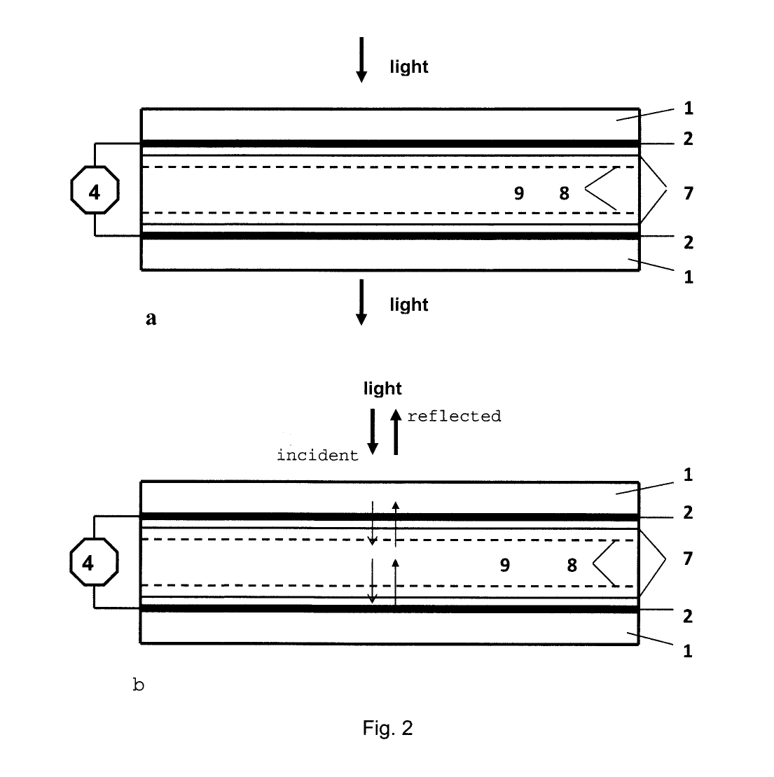

The solution of this problem is provided by the fact that in the known ferroelectric liquid crystal display cell (FIG. 2) comprising two parallel dielectric plates 1, at least one of which is transparent, and the inner surfaces of which are covered by the conductive coatings 2, at least one of which is transparent, connected to the alternating electric voltage generator 4, dielectric coating 7, which is applied over one or both of the conductive coatings and serves to protect the cell from the electrical circuit locking and breakdown, transparent anisotropic coating 8, determining the initial orientation of liquid crystal molecules in the absence of an external electric field, covered at least onto one dielectric coating 7, ferroelectric liquid crystal 9 filling the space between the anisotropic coatings 8, changing its optical anisotropy under the electric field action, the new is that the ferroelectric liquid crystal is selected helix-free, i. e. with the wave vector of the helix q₀=2π/p₀ tending to zero, and in it the values of rotational viscosity, spontaneous polarization and elastic modulus defining the deformation along smectic layers are in a specific ratio, namely: the value of rotational viscosity is in the range of 0.3<γ_{φ}<1.0 Poise, the magnitude of spontaneous polarization Pₛ is less than 50 nC/cm², and the modulus of elasticity K is in the range (1÷3)·10⁻¹² Newton.

Fulfilling the above ratio provides in a layer of helix-free FLC the compensation of the space charge created by the spontaneous polarization, and results in the periodic deformations of smectic layers in the absence of an electric field. Upon application of the control alternating electric field the periodic deformations axe the physical cause of variation of the birefringence and its characteristic dependence on the field change frequency. Thereby helix-free FLC differ from helix FLC in which the change of the birefringence is due to the deformation of the helix (without the pitch change) in an electric field.

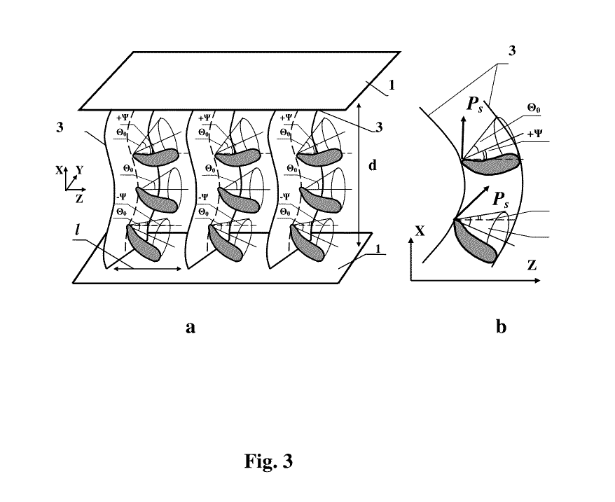

The presence of spatial periodic deformations in helix-free FLC means (FIG. 3) that in the smectic layers 3 the molecules FLC initially inclined at an angle Θ₀ relative to the normal to the layer at a given point are deflected additionally by an angle ψ with respect, to axis z. By means of this the director projection onto plane xy changes. Alternating electric field E applied along the coordinates x, interacts with the spontaneous polarization Pₛ and changes the distribution of the angle ψ, defining the deformation value of the smectic layers. Physically, this means a change of the type of energy dissipation and the transition of coefficients characterizing this dissipation from γ_{φ} to γ_{ψ}.

The development of this process results in the appearance of the soliton, which is a wave packet with localized in it periodic wave (in fact, a train of solitons). The velocity of the center of the soliton is defined as [21]:

$$V = \frac{{Θ}_{0}}{{γ}_{ψ}} {( 2 K ( {P}_{S} E cos {ϕ}_{0} + M ) - {( \frac{2 K}{d {Θ}_{0}} )}^{2} )}^{1 / 2} , \qquad ( 5 )$$

where K—the coefficient of elasticity, describing the deformation of the director on the angle ψ, γ_{ψ}—FLC shear viscosity, M—energy of smectic layers bending, φ₀—initial azimuth angle of the director orientation.

If the value γ_{φ} below 0.3 P, then the shear viscosity γ_{φ} is not achieved at modulation frequency increasing, and the soliton mechanism of FLC director orientation is not realized. If γ_{φ}≧1.0 P, then the optical response time significantly increases not only on small, but at high frequencies also, when the shear viscosity γ_{ψ} becomes responsible for the energy dissipation. With increasing the value of spontaneous polarization above 50 nC/cm² the saturation voltage increases, and therefore the operating voltage of FLC cell increases. At last, the values (1-3)·10⁻¹² Newton for the modulus of elasticity K characterize an interval, in which the smectic layers are stable and at the same time susceptible to the formation of periodic spatial deformations in the absence of an electric field.

Thus, the essence of the present invention is to provide conditions in the ferroelectric liquid crystal display cell that result in periodic changes of the director positions (of refractive index ellipsoid) along each of the smectic layers. Helix twisting of the director in FLC layer volume must be necessarily absent (suppressed) for this, that is provided by adding to the initial achiral smectic C matrix the optically active (chiral) components with opposite signs of optical activity until full quenching (compensation) of FLC optical activity [20].

The technical result of the invention is the creation of a ferroelectric liquid crystal cell with helix-free FLC, wherein certain ratio of magnitudes of the rotational viscosity, spontaneous polarization and modulus of FLC elasticity provide continuous hysteresis-free modulation characteristic, light modulation frequency of a few kilohertz and lower power consumption compared with the prototype [19], when a cell is addressed by alternating pulses of amplitude ±1.5 V.

In the first embodiment of this technical solution the liquid crystal cell is considered that modulates light when it passes through the cell once in one direction (FIG. 2a). In the second embodiment, the technical problem is solved by the same principle way, but unlike the first embodiment (when a cell passes the light) one of the conductive coating is reflective (FIG. 2b) that is typical for cells of reflective type.

The thickness of FLC layer is selected in the range of 0.9-1.4 micrometers to satisfy the condition of the achromatic light transmission in the wavelength range of light modulated in transmissive or reflective cell. In addition, the insulating coating can border with FLC layer on one side only.

Advantages of the proposed ferroelectric liquid crystal display cell are realized by means of choosing FLC with compensated helix and a certain ratio of magnitudes of the rotational viscosity, spontaneous polarization and modulus of FLC elasticity.

As a result, the main advantages of the inventive ferroelectric liquid crystal display cell in comparison with the prototype are: reduction of the control alternating voltage for cell addressing to ±1.5 V (i. e. twice relative to the level of maximum change in the intensity of the modulated light), which is more appropriate for high-addressable integrated circuits, as well as more stable light modulation with large optical contrast due to the lack of ferroelectric domains and helix structure, and hence its deformation. In this prior art it is not known that all these advantages can be achieved in the ferroelectric liquid crystal display cell by selecting the essential parameters in FLC with the compensated helix.

For improving the light modulation characteristics of the ferroelectric liquid crystal display cell one can individually or jointly use a varying the composition of the liquid crystal material, changing the regime of a cell control, differentiation of a cell design etc. For example, it is possible to use polymer-liquid crystal layers; dielectric plates (substrates) can be as thin flexible films; one of the dielectric plates (substrates) can be eliminated completely and reflective conductive coating in this case can be performed on the silicon wafer, in which a control integrated circuit is formed, and others.

Thus, the use of the inventive ferroelectric liquid crystal display cell provides in it the continuous hysteretis-free modulation characteristic at the control by alternating voltage pulses ±1.5 V, the light modulation frequencies of a few kilohertz, lower power consumption compared with the prior art and the best optical contrast. These results and features of the invention (absence of the helix in FLC and the ratio of essential parameters) are essential.

### INDUSTRIAL APPLICABILITY

Proposed ferroelectric liquid crystal display cell and the optical modulator based on it are low-voltage, high-speed, technologically advanced and efficient light modulation device. This allows their use in many modern and advanced displays, single channel and spatial light modulators, as well as in other information devices and systems of storage, converting, processing, visualizing and displaying information. Moreover, the application of the present invention will promote to achieving the limit speed (for such devices and systems) and the implementation of new functions, which cannot be achievable in liquid crystal devices today, because of their limited fast ability.

### EXAMPLE EMBODIMENTS

To carry out the present invention a few experimental samples of ferroelectric liquid crystal display cell and FLC based optical modulators were made and their characteristics were measured.

FLC with compensated helix possessed the following material parameters: the rotational viscosity γ₀=0.7 Poise, the spontaneous polarization P_{S}=40 nC/cm², and the elastic modulus K determining the deformation along the smectic layers is equal to 1·10⁻¹² Newton. The temperature range of the existence of ferroelectric phase of used FLC was in the range from +5° C. to +70° C.

The standard ITO layers were used as the electrically conductive transparent coatings on glass substrates. The aluminum dioxide film of 70 nm thickness manufactured by means of deposition was used as the dielectric coating. The polyimide film of about 30 nm thickness manufactured by means of centrifuging served as the transparent anisotropic orienting coating, and it was rubbed to impart properties to orient FLC.

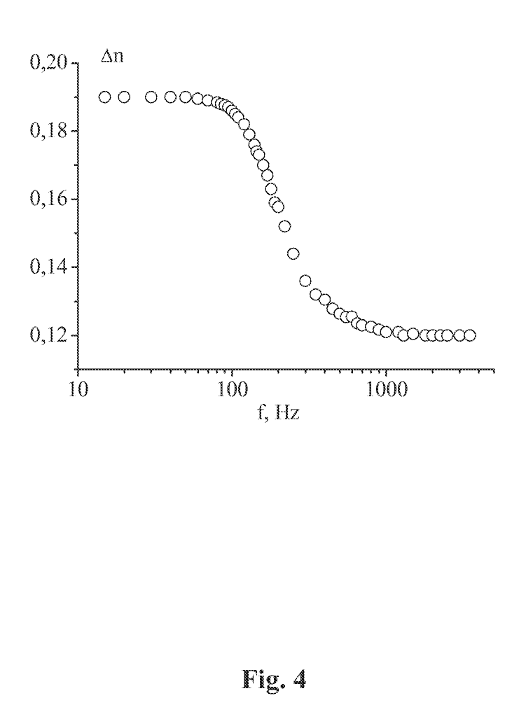

At the specified ratio between the magnitudes of the rotational viscosity, spontaneous polarization and modulus of elasticity the birefringence index Δn exhibits a characteristic dependence on the frequency f of the electric field (FIG. 4) that indicates on the emergence in helix-free FLC the spatial periodic deformations of the smectic layers, resulting in the soliton mechanism of reorientation of FLC director. In the case of the homeotropic orientation of the director of helix-free FLC (smectic layers are parallel to substrates of the electro optical cell), these deformations were observed behind the crossed polarizers in the form of alternating light and dark stripes with a period from 1.5 to 5 microns, which depends on FLC molecular structure.

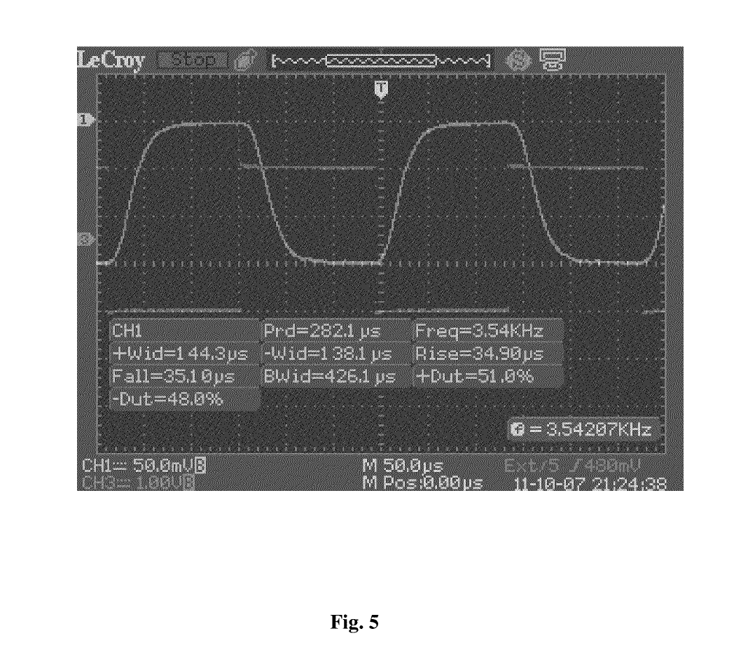

Experiments have shown that the transition to the soliton mode occurs at the control voltage frequency of the order of 170 Hz. In this mode the electro-optical response time is determined by the speed of soliton waves movement (equation 5) and rather weakly depends on the frequency of the control voltage. The maximal frequency of light emission modulation at the amplitude of the control voltage (meander) ±1.5 V in a cell of 1.7 micrometer thickness was 3.5 kHz (FIG. 5). In the presented oscillogram the upper level of the electro-optical response is a closed state, the bottom—transmissive state, and electro-optical response time on the front edge—Rise, on the back edge—Fall. This oscillogram also indicates that the time of electro-optical response of the cell with helix-free FLC, compared with the same response of the cells with helix FLC decreased by 15-20 microseconds for both polarities of the applied voltage.

### REFERENCES

1. Blinov L. M. Electro- and magneto liquid crystals. Nauka, Moscow (1978).
2. Vasiliev A. A., Kasasent D. Kompanets I. N., Parfenov A. V. Spatial light modulators. Moscow, Publishing House “Radio and Communication”, 380 pp. (1987).
3. Chigrinov V. G. Liquid Crystal Devices: Physics and Applications. Artech House Publishers, London, 359 p. (1999).
4. Anderson J., Chen C, Bos P. Liquid Crystal Designs for High Contrast Field Sequential Color Liquid Crystal on Silicon (LCoS) Microdisplays. Proceedings of SPIE, v. 5741 (“Emerging Liquid Crystal Technologies”), 23-30 (2005).
5. Belyakov V. A, Dmitrienko V. E. Blue-phase liquid crystals. Physics-Uspekhi, v. 146, 369-415 (1985).
6. Matt Brennesholtz. Digital Cinema Summit: To 4K and Beyond. Display Daily, 11.04.2011—http://displaydaily.com/2011/04/11.
7. Loseva M. V., Pozhidaev E. P, Rabinovich A. Z., Chernova N. I., Ivaschenko A. V. Ferroelectric Liquid Crystals. VINITI, the results of science and technology, a series of “Physical Chemistry”, v. 3, Moscow (1990).
8. Lagerwall S. T. Ferroelectric and Antiferroelectric Liquid Crystals. WILEY-VCH Verlag GmbH, Germany, pp. 241-257 (1999).
9. Andreev A., Kompanets I., Pozhidaev E., Zerrouk A. Advances of FLC device technology. Proc. SPIE, v. 4511, 82-91 (2001).
10. Ostrovsky B. I., Chigrinov V. G. The linear electro-optic effect in chiral smectic C* liquid crystals. Crystallography, v. 25, 322-331 (1980).
11. Clark N. A., Lagerwall S. T. Sub-microsecond switching in ferroelectric liquid crystals. J. Appl. Phys., v. 36, 899-903 (1980).
12. Samarin A. LCoS-microdisplays and their application. Components and technologies. No 8, 24-32 (2008).
13. O'Callaghan M. J., Handschy M. A. Ferroelectric liquid crystal SLMs: from prototypes to products. Proc. SPIE, v. 4457, 31-42 (2001).
14. Beresnev L. A., Blinov L. M., Dergachev D. I., Kondratiev S. B. Electro-optic effect in ferroelectric liquid crystal with a small pitch of the helix and the high value of the spontaneous polarization. Pisma v ZHETF, v. 46, #8, 28-330 (1987).
15. Beresnev L. A., Chigrinov V. G, Dergachev D. I., Pozhidaev E. P., Funfshilling J., Shadt M. Deformed helix ferroelectric liquid crystal display—a new electrooptic mode in ferroelectric smectic C* liquid crystals. Liquid Crystals, v. 5, #4, 1171-1177 (1989).
16. Pozhidaev E. P., Minchenko M. V., Shadura O. A., Andreev A. L., Kompanets I. N., Chigrinov V. G. Stability of hysteresis-free passively addressed FLC display with inherent gray scale. SID-07 Symposium Digest, v. 38, Book 2, 1078-1081 (2007).
17. Pozhidaev E., Chigrinov V, Du T., Kotova S., Minchenko M., Vashchenko V, Krivosey A., Fei F. Fast and Hysteretic Free 0-2 Phase Modulation of the Light in Electrically Controlled Weakly Deformed Short Helix Pitch Ferroelectric Liquid Crystal. Proc. of the 29^{th} IDRC (Eurodisplay-09, Rome), Publishing House [symbol] Dalaad Edizioni [symbol] , 398-401 (2009).
18. Chigrinov V. G., Pozhidaev E. P., Murauski A. A., Kwok H. S. Liquid Crystal Display Cell with Fast Response and Continuous Gray Scale. U.S. Provisional Patent Application, #61/344,070, (Ref.: TTC.PA.0463), filed on May 18 (2010).
19. Andreev A. L., Andreeva T. B., Kompanets I. N. RF Patent No 2430393 “Ferroelectric liquid crystal display cell” (priority of Nov. 3, 2010).
20. Beresnev L. A., Baikalov V. A., Blinov L. M., Pozhidaev E. P., Purvanetskas G. V. The first non-helical ferroelectric liquid crystal. Pisma v ZHETF, v. 33, no. 10, 553-557 (1981).
21. Fedosenkova T. B., Andreev A. L., Pozhidaev E. P., Kompanets I. N. Electrically controlled the birefringence in helix-free ferroelectric liquid crystals. Bulletin of the Lebedev Physical Institute, No 3, 45-52 (2002).

1. Ferroelectric liquid crystal display cell comprising two parallel dielectric plates, at least one of which is transparent, and the inner surfaces of which are covered by the conductive coatings, at least one of which is transparent, connected to the alternating electric voltage generator, dielectric coating, which is applied over one or both of the conductive coatings and serves to protect the cell from the electrical circuit locking and breakdown, transparent anisotropic coating, determining the initial orientation of liquid crystal molecules in the absence of an external electric field, covered at least onto one dielectric coating, ferroelectric liquid crystal (FLC) filling the space between the anisotropic coatings, changing its optical anisotropy under the electric field action, the new is that the ferroelectric liquid crystal is selected helix-free, i. e. with the wave vector of the helix q₀=2π/p₀ tending to zero, where p₀ is the helix pitch, the value of rotational viscosity is in the range of 0.3<γ_{φ}<1.0 Poise, the value of spontaneous polarization Pₛ does not exceed 50 nC/cm², and the magnitude of elastic modulus K defining the deformation along smectic
